(19) United States
(12) Patent Application Publication
(10) Pub. No.: US 2016/0284022 A1
(43) Pub. Date: Sep. 29, 2016

(54) SYSTEM AND METHOD FOR AUTOMATED DIGITAL CURRENCY SAVINGS PLATFORM

(71) Applicants: Adam Mark Weigold, Stateline, NV (US); Shallen Wade, North Adelaide (AU)

(72) Inventors: Adam Mark Weigold, Stateline, NV (US); Shallen Wade, North Adelaide (AU)

(21) Appl. No.: 14/666,310

(22) Filed: Mar. 24, 2015

(51) Int. Cl. G06Q 40/06; G06Q 20/10; G06Q 20/22

(52) U.S. Cl. CPC G06Q 40/06; G06Q 20/227; G06Q 20/108

(57) ABSTRACT

A system and method for an automated digital currency savings platform that uses customer credit card transactions, debit card transactions and other fiat currency transactions to automatically trigger regular user-adjustable savings contributions to the customers online financial savings vehicle comprising of one or more digital currency, virtual currency or crypto-currency accounts. The present invention includes various methods for the calculation of digital currency savings contributions for the customer, and various methods for the design and operation of the platform by the platform vendor. The present invention also relates to the currency conversion exchange between fiat currencies and digital currencies, and also to the provision of additional interest payments or reward contributions towards the balance of the customers digital currency savings account or accounts.

### CROSS-REFERENCE TO RELATED APPLICATIONS

This application is related to and claims priority under 35 USC.sctn.119 from U.S. Provisional Application No. 61/970,256 filed Mar. 25, 2014 entitled “SYSTEM AND METHOD FOR AUTOMATED DIGITAL CURRENCY SAVINGS PLATFORM” which is incorporated fully herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### STATEMENT REGARDING PRIOR DISCLOSURES BY A JOINT INVENTOR

Not Applicable

### BACKGROUND OF THE INVENTION

1. Field of the Invention

The present invention relates to an online financial savings platform that uses customer spending transactions in traditional fiat currencies such as US dollars or Euros to automatically trigger savings contributions to an online financial savings and investment vehicle for the customer that comprises of one or more digital, virtual or crypto-currency accounts such as Bitcoin or Litecoin. The present invention also relates to the conversion exchange between fiat currencies and digital currencies, and also to the provision of additional interest payments or reward contributions towards the balance of the customers digital currency savings account.

2. Description of Related Art

The use of credit cards and debit cards to perform daily purchases and other financial transactions is widespread throughout modern society. Furthermore, the use of credit card transactions to earn the customer bonus rewards for membership and loyalty programs is well known. Typically these membership rewards or points are earned proportional to the size of each transaction and can be exchanged for certain goods, services or rebates after accruement over time. The purpose of these credit card membership programs is to encourage loyalty and preferred use of the vendor's credit card over competitive cards. The credit card vendor, typically a bank or large corporation, makes a financial profit by charging interest on the borrowed balance of the credit card. The vendors profit on a certain balance is typically many times more than the value of goods, services or rebates received by the customer through earning points. Examples of credit card reward systems in the prior art include Freiberg (2004) in U.S. Pat. No. 7,949,559B2 and Hart (2012) in US Patent Application 20130080237A1. Of particular relevance is Hardesty (1998) in U.S. Pat. No. 6,105,865A which describes a credit card reward system where the reward offered by the vendor is a financial rebate in fiat currency stored in a trust account for long term retirement savings purposes.

Most banks and credit card vendors charge customers a high interest rate on their borrowings with charges exceeding the value of any rewards or rebate that can be earned through repeated use of the credit card. In general the greater the reward value offered by the bank or card vendor the even greater the interest rate that is charged to the customer. Most banks also offer debit cards that have no reward or loyalty programs. These cards are popular with customers who want the convenience of a credit card but do not need credit, do not want to apply for credit or do not want to pay interest charges. Debit cards operate effectively as bank savings or checking accounts that can earn interest and be used in the same way as a credit card. Interest payments to the customer are typically offered as a monthly or annual percentage on their average account balance. However recently interest rates offered to customers on fiat currency savings accounts are very low and often below 1% per annum. Furthermore account keeping and transaction fees can also apply to these accounts making most savings accounts and debit card accounts costly to maintain without large balances being maintained.

The primary advantages of credit cards and debit cards for everyday financial transactions are their convenience of use and widespread acceptance with merchants. The primary advantage of savings investment accounts is the earning of accrued interest on the customers' account balance. However the primary disadvantages of credit cards and debit cards are large account keeping fees, large transaction fees, and relatively low levels of customer security against theft, fraud or loss. Furthermore credit cards typically suffer from high interest rate charges for the customer while debit cards and traditional savings accounts typically suffer from low interest rates earned. Consequently the poor interest rates offered by traditional banks and high bank charges act to significantly diminish the advantages of fiat currency credit card, debit card and savings investment accounts.

Recent advances in computer, internet and smartphone technologies have resulted in many banks now offering online and mobile banking services to customers. Examples of online banking systems and services include Boyd et al. (20012) in U.S. Pat. No. 8,185,472 and Griggs (2013) in U.S. Pat. No. 8,407,142. Unfortunately many online banking software platforms can dramatically increase the risk of fraud, theft or loss for the customer. Traditional banking infrastructure is not capable of providing high levels of online security without significant self-management by the customers. Online banking details such as bank account numbers, usernames and passwords are now stored on the customers' personal computer, tablet or smartphone device. Consequently customers are now responsible for much of their own banking security and are well advised to guard against theft with anti-virus, anti-hacking and anti-spyware software. This means decreased liability for the bank or credit card vendor and increased liability for the customer. However many customers do not install sufficient anti-theft software protection on their personal computers or mobile smart devices. Ultimately, the advent of smart digital technology and the internet has made credit card and debit card use more vulnerable to fraudulent attack. This is reflected by the recent increase in software based credit card fraud via internet and mobile devices, compared to a recent decrease traditional credit card fraud using credit card scanning hardware or physical theft.

Nonetheless modern technology now makes it theoretically possible for customers to perform all personal and business banking transactions to anywhere in the world in a matter of seconds or minutes with very high levels of transaction security. The digital nature of all modern financial systems means that most transactions can now in principle be performed without the involvement of banks, fees or delays. However, despite these recent advances in technology becoming available, most domestic and international banking transactions still take from between a day to over a week to be processed and completed. Most transactions also still incur high bank fees. Consequently online banking services currently offered by traditional banks can only be described as slow, expensive and risky for the customer. This is in part due to the widespread reliance on existing credit card and debit card infrastructure which is being subject to increasing amounts of theft and fraud.

Recently digital currencies or crypto currencies have emerged as an alternative to traditional fiat currencies and credit card infrastructure. Fiat currencies typically represent the tradable currency of a particular nation such as the US dollar, or a group of nations such as the Euro. Trade in fiat currencies suffers the disadvantages of value manipulation by government, bank account fees, transaction fees and taxes, and a lack of privacy or anonymity. The involvement of traditional banks in the process dramatically slows transaction speed and increased costs for the customer. Moreover it is unnecessary from a technical point of view, given the instant and free online connection available to many computer and mobile devices over the internet. Digital currencies have the potential to displace traditional banks from online banking markets.

The recent advent of digital currencies is primarily due to the desire for a fast, secure, transparent, easily tradable international currency that can be safely and instantaneously transferred online between users, is immune to manipulation by governments, involves no bank fees or taxes, and provides increased privacy and anonymity for both the customer and vendor. Digital currency accounts or wallets have great potential to displace credit card and debit card accounts for many everyday transactions due to their lower cost and potentially safer use online Digital or crypto currencies are typically based on valuation and exchange of currency via a peer-to-peer distributed network of computers.

The value of a digital currency may be determined purely via the laws of supply and demand. Supply of new currency is typically achieved via the use of networked computer processing power to verify every transaction and manage the network in a process called “mining”. Demand is typically achieved via the analysis of the volume and size of all currency transactions. In a common embodiment all transactions are recorded in multiple nodes of a distributed network of computers or servers that simultaneously determine the instantaneous value of the currency at any one time. The value and date of every digital transaction is totally transparent because it is used by the entire computer network to determine the currency value. This results in vastly increased levels of security against transaction fraud as the value and date of every transaction is verified on every computer on the network. However the identity of both the customer and merchant, or the transmitter and receiver, are only known to themselves. This is typically achieved using a set of private and public cryptographic security keys or addresses. Consequently digital currency transactions are fast, secure, private and free of taxes and bank fees. Furthermore the highly volatile and exponential growth that can be exhibited by a digital currency in the early stages of its adoption can make it a highly attractive investment for both speculative and long term investors. Compared to fiat currencies digital currencies have far greater potential to offer high investment returns for the customer. Examples of digital, virtual or crypto currencies include Bitcoin, Litecoin and Dogecoin and are described in many online publications and patent documents including Morgenstern et al. (2012) in U.S. Pat. No. 8,255,297.

One major problem for digital currencies arises from the anonymity of the users and the lack of a regulatory control that administers best practices and standards. Consequently digital currencies have often been used by criminals for money laundering purposes and by others for tax avoidance purposes. In addition online theft or fraud of digital assets remains a significant problem for digital currencies, just as with fiat currencies and credit cards. This is in large part due to the ignorance of customers about security protocols for digital currencies and a lack of care about their personal information stored online Ultimately any digital information that is stored on a computer device connected to the internet, whether it is in digital currency or fiat currency, is subject to potential theft from computer hackers and potential loss or damage of the computer device and information contained within. Furthermore the lack of a central regulatory control for distributed digital currencies may mean that there is no legal recourse for customers who have been victim to theft, fraud or loss. However most of these disadvantages can be overcome if the customer is willing to sacrifice some level privacy and supply personal details to a trusted digital currency bank or exchange. It is important to note that the level of personal information required for more secure transactions in digital currency could be considered to be the same level of personal information that is already required by traditional banks for credit card and debit card accounts.

In summary, both digital currencies and fiat currencies have their respective advantages and disadvantages. Digital currencies offer fast, secure, anonymous transactions that are free of taxes and bank fees Importantly they also offer high return investment opportunities when compared to investment in traditional fiat currencies. The peer-to-peer distributed nature of digital currencies combined with cryptographic encoding results in transparent transactions that cannot be falsified whilst maintaining a very high level of security for the user. However digital currencies lack a central regulatory control and user anonymity can enable illegal activities such as money laundering to occur. Consequently digital currencies can be subject to misuse and fraud, unless a certain amount of user information is supplied to the digital currency bank or vendor. While the digital currency market is currently at an early stage of development and consumer acceptance, the lack of regulatory control presents a barrier to the mainstream consumer market as an accepted payment format. Nonetheless digital currencies represent a potential high return investment for both speculative and long term investors compared to fiat currency savings and investment vehicles. Conversely traditional fiat currencies and existing credit/debit card infrastructure are highly regulated and offer widespread acceptance with merchants and ease of use by the customer. However they also suffer from the disadvantages of high banking fees, long transaction delays, relatively poor investment returns and very poor security against theft or fraud.

### BRIEF SUMMARY OF THE INVENTION

According to the present invention there is provided a system and method for an automated online financial saving, investment and banking platform that incorporates a distributed peer-to-peer network of computer hardware devices and cryptographically encoded software to provide an automatic, highly secure, fast and low cost savings and investment vehicle for digital currency or crypto currency assets, and to provide a method for customers to earn additional interest based on the value of their contributions to their digital currency account. The present invention can be described as an automated savings platform for digital currency investments that uses traditional credit and debit card transactions to initiate automated funding of the customers digital savings vehicle. The customer also has the ability to earn additional interest or reward contributions for their digital savings account by contributing processing power to the distributed network for purpose of mining digital currency. The vendor of the banking platform has the ability to charge fees for provision of automated contribution and currency exchange services, and for provision of digital currency mining services that provide additional interest or rewards for the customer.

In a first embodiment of the invention, although this should not be seen as limiting the invention in any way, automated savings of digital currency is achieved via seven separate processes or steps, comprising;

an initial step wherein the customer registers their credit card and/or debit card account details and any additional personal information required with the vendors online Digital Currency Savings Platform (DCSP), their account details are then verified by the DCSP platform, and then a digital currency account or wallet is automatically created for the customer;

a second step wherein the customer chooses their preferred savings rate, security options and privacy management options via the online DCSP software interface;

a third step wherein the customer makes a financial purchase or payment in fiat currency using their registered credit card or debit card;

a fourth step wherein the DCSP software regularly monitors the customer's transactions according to privacy and security management options chosen by the customer;

a fifth step the DCSP software automatically charges the customer's credit or debit card account an additional savings contribution charge in fiat currency at the customers selected savings rate that could be equal to either a percentage of each transaction or a fixed fee per transaction;

a sixth step wherein the savings contribution charge is converted from fiat currency to a digital currency, using either an internal currency exchange platform or an external 3^{rd} party currency exchange platform; and

a seventh and final step wherein the savings contribution in digital currency is deposited into the customers' digital currency account or wallet, less any fees charged by the DCSP operator or vendor for use of the platform.

The digital currency wallet may typically store the customers' digital currency account information online via a central or distributed network, locally on a mobile smart device, or remotely offline on paper or dedicated electronic storage device. The DCSP vendor may provide a digital currency wallet product and also accept existing 3^{rd} party digital currency wallets. To deter customers from fraudulently using digital currency accounts or from participating in illegal activities using digital currency transaction the customer may be required to provide a range of personal details to the DCSP vendor including, name, age, address, credit card number or social security number. This process may be incorporated in the first process when the customer registers their credit card or debit card details with the DCSP vendor. In addition the vendor may or may not offer the customer additional savings interest rates or reward contributions in digital currency depending on the specific nature of the savings investment product. Consequently the present invention provides a method for a fast, easy-to-use, low cost, safe and secure savings investment vehicle for customers to automatically invest in digital currency financial products every time they spend fiat currency using credit and debit cards with 3^{rd} party merchants or vendors.

In a second embodiment of the invention, although this should not be seen as limiting the invention in any way, the DCSP vendor pays the customer regular interest payments to their digital wallet calculated as a percentage of the customers' minimum monthly or annual account balance. The vendor may fund these customer interest payments by pooling the balances of multiple customer accounts together and investing the pool in other digital currency investments that offer higher returns than offered to the customer. It is important to note that this embodiment of the present invention may require the customer to disclose additional private information to the vendor, and/or authorize the vendor to access and manage the customers digital currency funds on the customers behalf.

In a third embodiment of the invention, although this should not be seen as limiting the invention in any way, the DCSP vendor pays the customer regular reward contributions calculated as a percentage of the customers' monthly or annual contribution of computer processing power to the distributed peer-to-peer network for the purpose of mining digital currency. Reward contributions may typically be earned by the customer visiting the online web site of the DCSP vendor and automatically connecting to the vendors' digital currency mining pool network. The total value of new digital currency mined by the DCSP vendor mining pool network provides funding for reward contributions to customer accounts and ongoing vendor profit.

Digital currency investments typically offer significantly higher financial returns than fiat currency investments. This enables vendors of digital currency savings products to offer higher interest rates and reward contributions on the balance of their savings accounts. The present invention is the first published example of credit card and debit card transaction being used to automatically provide a secure investment vehicle where customers gradually and regularly accrue value in digital currencies for long term savings and investment purposes. The frequent and widespread use of credit and debit cards makes them ideal transaction vehicles for customers to regularly save assets in digital currency with small micro-payments whenever they spend traditional fiat currency. This offers the advantage of customer savings contribution levels being determined by regular customer spending habits, and hence is a measure of what customers can comfortably and realistically afford to save. Furthermore, the online management of the customers' credit card, debit card and digital wallet information using a cryptographic software platform on a distributed peer-to-peer computer network offers the potential of vastly improved security levels against theft, fraud or loss for both digital and fiat currency accounts. It is important to note that the customer receives these additional security benefits without having to disclose any more personal or banking information than is typical with standard credit card and debit card transactions. Consequently increased bank account security is achieved without the requirement of sacrificing customer privacy beyond traditional fiat currency banking requirements.

In summary, the present invention is described as a digital currency savings platform that provides customers with a highly secure, fast, low cost, easy-to-use and affordable method for accruing savings in digital currencies every time they use their credit card or debit card for fiat currency merchant transactions. The potential for growth in the value of digital currency assets is typically much larger than the potential for growth in the value of fiat currency assets, and also typically larger than the value of any interest that can be earned by keeping assets in fiat currency savings accounts. Preferred embodiments of the present invention also offer customers additional interest benefits and reward contributions that are based on either the customers account balance or their relative contribution of computer processing power to digital currency mining activities performed on the DCSP vendors distributed online network. Various other potential embodiments of the invention may be developed without departing from the scope and ambit of the invention.

### BRIEF DESCRIPTION OF THE DRAWING

By way of example, employment of the invention is described more fully hereinafter with reference to the accompanying drawings, in which:

FIG. 1 shows a schematic overview of an embodiment of the present invention described as an automated Digital Currency Savings Platform (DCSP) that uses credit card and debit card transactions to initiate repeated micro-investments that are deposited in a digital currency savings account or wallet.

### DETAILED DESCRIPTION OF THE INVENTION

According to a first aspect of the present invention, there is a system and method for a vendor to provide customers with a digital currency savings vehicle comprising an online software platform that automatically;

monitors all transaction activity and usage of customer credit card and debit card accounts;

charges a user selectable savings contribution to the customers' credit card or debit card account every time they use that card for the purchase of goods or services from any 3^{rd} party merchant or vendor, or payment of currency to any 3^{rd} party, in any traditional fiat currency;

converts the savings contribution charge from the fiat currency into a digital currency;

charges the customer a currency conversion and platform usage fee in digital currency which is retained as revenue or profit by the vendor;

deposits the savings contribution charge, less the currency conversion and platform usage fee, into the customers digital currency savings account; and optionally

deposits additional interest payments or reward contributions earned by the customer into the customers digital currency savings account, paid at the discretion of the vendor and dependent on the customers savings account balance and/or their level of usage of the online software platform.

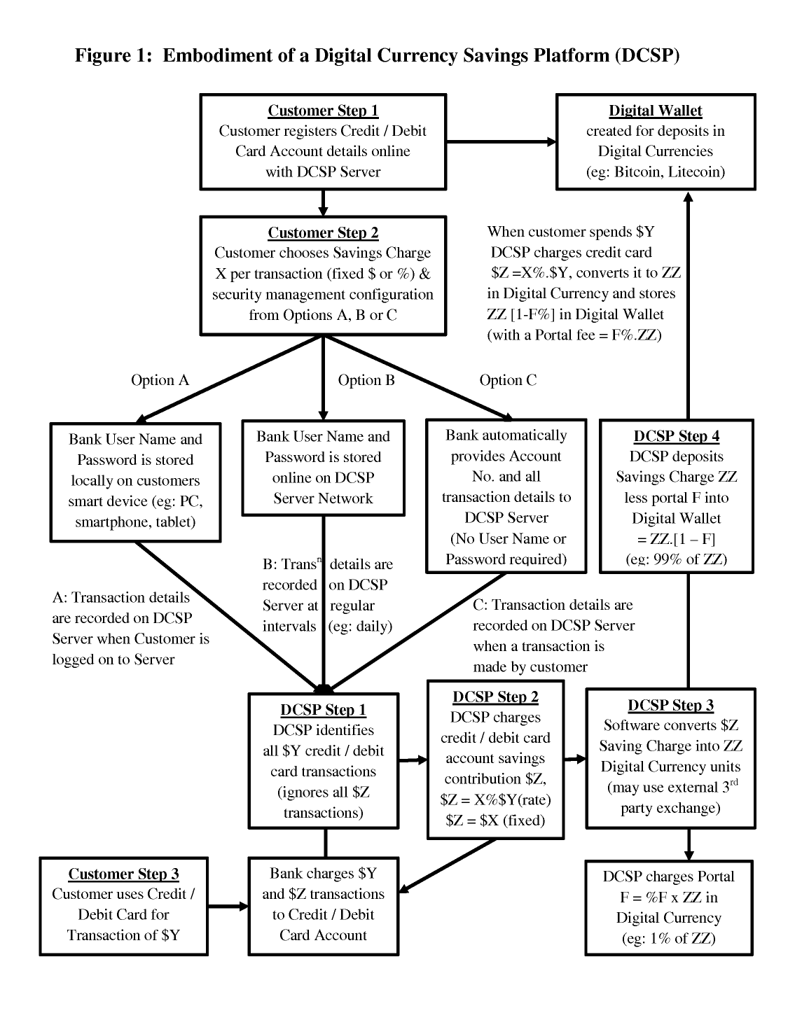

In a first embodiment of the invention described in FIG. 1, although this should not be seen as limiting the invention in any way, automated savings of digital currency using credit card or debit card transactions in fiat currency is achieved via seven separate and distinct steps. Three of these steps are performed by the customer while the remaining four steps are performed automatically by the online software engine of the Digital Currency Savings Platform (DCSP). The schematic shown in FIG. 1 represents this preferred embodiment and details the various steps involved in the operation and use of the vendors DCSP software engine by the customer.

The first step, described as Customer Step 1 in FIG. 1, involves the customer registering and verifying their credit card or debit card account details online with the vendors DCSP software. The vendor may require additional personal information from the customer during this step to determine the level of security management and interest payment options that can be provided to the customer by the vendor. This step also involves the DCSP automatically creating a digital currency account or wallet for the customer. The digital currency wallet is able to store customer deposits in one or more digital currencies and may also be configured in a multiple of storage formats including online cloud server based storage, online distributed network based storage, local mobile app based storage or offline remote based storage. Additionally the vendor may permit the customer to use a pre-existing digital currency account or wallet from a 3^{rd} party vendor for the accrual of savings contributions.

The second step, described as Customer Step 2 in FIG. 1, involves the customer choosing their preferred savings options and security management options. Savings options comprise a savings contribution charge X in fiat currency that may be either a fixed charge per transaction $X, or a percentage rate charge X % of the value of each transaction. Security management options may comprise, but are not limited to, Option A, Option B and Option C that are indicated in FIG. 1 and described more specifically as follows;

Option A involves the storage of the customers' personal online banking details for credit card and debit card accounts, including their user name and password, locally on the customers own computer device, tablet device or smartphone. In this case the customer may not be required to have submitted any additional personal information in Customer Step 1. However customer credit and debit card transactions can only be identified, and subsequent savings contributions can only be charged, while the customers' computer device, tablet or smartphone is connected online to the DCSP via the internet;

Option B involves the storage of the customers' personal online banking details for credit card and debit card accounts, including their user name and password, online on either a DCSP central server or a DCSP distributed peer-to-peer network. In this case the customer is required to have submitted additional personal banking information in Customer Step 1. However customer credit and debit card transactions can be identified, and subsequent savings contributions can be charged, on a regular or periodic basis irrespective of whether the customers computer device, tablet or smartphone is connected online to the DCSP or not; and

Option C involves the continual updating of the customers' credit card and debit card transactions to the DCSP by the customers fiat currency bank or credit card vendor. Typically this option requires a pre-existing partnership agreement and communication system between the DCSP vendor and the customers' bank or credit card vendor. In this case storage of the customers' personal online banking details for credit card and debit card accounts, including their user name and password, is not required by the DCSP and the customer is not be required to have submitted any additional personal information in Customer Step 1. Moreover the customers' credit and debit card transactions can be identified, and subsequent savings contributions can be charged, as soon as they are processed and approved by the customers' fiat currency bank or credit card vendor.

The third step, described as Customer Step 3 in FIG. 1, involves the customer purchasing goods or services from a merchant, or making a financial payment to 3^{rd} party, for a total of $Y in fiat currency using their credit card or debit card account. The customers bank or credit card vendor subsequently verifies and approves of the customers purchase and stores the transaction information $Y so that either the customer or the DCSP can access it online using the customers online banking account details including username and password. In the case that Option C is used as the security management option in the second step, the bank or credit card vendor automatically communicates the value of the $Y transaction to the DCSP as soon as the transaction has been approved.

The fourth step, described as DCSP Step 1 in FIG. 1, involves the DCSP software engine monitoring and identifying all $Y transactions made by the customer using their credit card or debit card accounts. If Option A has been chosen in the second step then this fourth step requires the customers' computer devices, tablet or smartphone to be connected to the DCSP and allowing the DCSP temporary access to the customers online banking information. If Option B has been chosen in the second step then this fourth step is performed automatically on a regular and period basis by the DCSP, including but not limited to monitoring the customers transactions on an hourly, daily, weekly or monthly basis. If Option C has been chosen in the second step then this fourth step is performed by the DCSP by identifying all $Y transactions that are automatically communicated to it by the customers bank or credit card vendor. The DCSP identifies all $Y transactions made by the customer by ignoring all $Z savings transactions that are charged to the customer by the vendor.

The fifth step, described as DCSP Step 2 in FIG. 1, involves the DCSP automatically charging the customer's credit/debit card account an additional savings contribution charge $Z in fiat currency. Depending on the savings option chosen by the customer in the second step, this savings contribution charge $Z will be either a fixed charge per transaction equal to $X, or a percentage rate charge of each transaction equal to X % multiplied by the transaction value $Y.

The sixth step, described as DCSP Step 3 in FIG. 1, involves converting the savings contribution charge $Z from a fiat currency such as US Dollars or Euros into the equivalent value ZZ in a digital currency such as Bitcoin or Litecoin. This step may be performed using either an internal digital currency exchange platform operated by the DCSP vendor, or an external digital currency exchange platform operated by a 3^{rd} party. This step may also involve the customer being charged a currency conversion fee by the 3^{rd} party currency exchange, the DCSP vendor, or both. It is important to note that all currency conversion fees can be included in a single final rate or total price quoted to the customer for each completed currency conversion and savings transaction.

The seventh and final step, described as DCSP Step 4 in FIG. 1, involves the savings contribution ZZ in digital currency, less any platform usage fees F charged by the DCSP vendor for use of the platform, being automatically deposited into the customers' digital currency account or wallet. The platform usage fee F may be charged in digital currency as either a percentage rate F % of every savings contribution charge ZZ, or as a fixed fee F per savings contribution charge ZZ. As a typical example the customer is charged a 1% platform usage fee for every savings contribution transaction ZZ which may be stored in the DCSP vendors' digital wallet account, or alternatively converted back into fiat currency and stored in the DCSP vendors' fiat currency bank account. As in the sixth step with currency conversion fees, all platform usage fees can be included in a single final rate or total price quoted to the customer for each completed currency conversion and automated savings transaction.

In a second embodiment of the invention described in FIG. 1, although this should not be seen as limiting the invention in any way, the DCSP vendor pays the customer regular interest payments to their digital wallet calculated as a percentage of the customers' minimum monthly or annual account balance. The vendor may fund these customer interest payments by pooling the balances of multiple customer accounts together and investing in other digital currency investments that offer higher returns than offered to the customer. These potential high return investments for the vendor may include options, derivatives and currency exchange trading in digital currencies. This is analogous to the way traditional banks pool their customers' assets and then invest in higher return, higher capital investments that provides both interest for their customers and profit for themselves. It is important to note that digital currencies typically offer higher returns than fiat currencies for both long term savings investments and short term speculative investments. Therefore customers can expect to receive significantly better returns on their digital currency savings balances compared to traditional fiat currency savings accounts. It is important to note that this embodiment of the present invention may require the customer to disclose additional private information to the vendor, and/or authorize the vendor to access and manage the customers digital currency funds on the customers behalf.

In a third detailed embodiment of the invention described in FIG. 1, although this should not be seen as limiting the invention in any way, the DCSP vendor pays the customer regular reward contributions calculated as a percentage of the customers' monthly or annual contribution of computer processing power to the distributed peer-to-peer network for the purpose of mining digital currency. This contribution may be earned by the customer visiting the online web site of the DCSP vendor and automatically connecting to the vendors' digital currency mining pool. Consequently the customer may earn additional reward payments by spending additional time with their computer connected online via the internet to the DCSP vendor network. Furthermore the customer may earn additional reward contributions by using multiple computers all connected online via the internet to the DCSP vendor network. The distributed pooled network of customer computers may constitute the entire mining pool network, or it may also compliment the vendors own central internal server network of computers that participate in mining digital currencies to provide initial scale and a minimum level of income from mining activities. Such a distributed peer-to-peer mining pool network may be used to mine multiple different digital currencies simultaneously. This can be achieved by allocating computer processing power in relative proportions according to the relative mining returns of the various currencies at any one time. The total value of new digital currency mined by the DCSP vendor network provides funding for all reward contributions to customer accounts and ongoing vendor profit. A percentage of new digital currency mined may also be re-invested into growing mining activities by adding more computer hardware and processing power to the vendors' central internal network. This may enable the total mining capacity of the DCSP vendor network to grow with, or even outgrow, the growth in the number of customers, value of customer account balances and value of interest paid to customer accounts.

In summary of the specific details discussed herein, the present invention can be simply described as a novel digital currency savings platform that uses traditional credit and debit card transactions to automatically trigger and fund savings and investments in digital currency. Various preferred embodiments of the invention offer customers faster, simpler, easier, safer, more affordable and more profitable methods for savings and investment in digital currency than is currently commercially available or published in prior art. The present invention represents a significant and innovative advance in online banking technology and digital currency investment products. Various modifications may be made in details of design and construction of the invention and process steps, parameters of operation etc. without departing from the scope and ambit of the invention.

What is claimed is:

1. A method for the automated financial savings of digital currency assets for customers using an online software platform provided by a vendor, that automatically performs the steps of;
monitoring of all customer financial transaction activity and usage of the customers' specified credit card accounts, debit card accounts and other banking accounts;
calculating and then charging of a user selectable savings contribution to the customers' credit card account, debit card account or other bank account every time the customer uses that card or account for the purchase of goods or services from any third party merchant, or every time the customer makes a payment in fiat currency from their selected bank account to a third party bank account;
converting the user selectable savings contribution charge from the original fiat currency into a specified digital currency via a currency exchange platform or service;
charging the customer a currency conversion and platform usage fee in either digital currency or fiat currency which is retained as revenue or profit by the vendor; and
depositing the converted user-selectable savings contribution charge, less the currency conversion and platform usage fee, into the customers specified digital currency savings account or accounts.

2. The method of claim 1, wherein the vendors online software platform performs the additional step of calculating and depositing additional interest payments or reward contributions, earned by the customers frequent or long term usage of the vendors online software platform, into the customers digital currency savings account or accounts.

3. The method of claim 1, wherein the user selectable savings contribution amount can be calculated as a percentage of each customer transaction amount.

4. The method of claim 1, wherein the user selectable savings contribution amount can be calculated as a fixed amount per individual customer transaction.

5. The method of claim 1, wherein the user selectable savings contribution is calculated as the difference between the customer transaction amount and the nearest larger integer of primary fiat currency units; for example when the user selectable savings contribution for an individual transaction is calculated as the difference between the transaction amount in dollars and cents and the nearest rounded up whole dollar amount greater than the transaction amount.

6. The method of claim 1, wherein the monitoring of all customer financial transactions and the charging of the user selectable savings contribution requires the input of specific bank account data by the customer and authorization from the customer.

7. The method of claim 1, wherein the monitoring of all customer financial transactions requires the use of an external financial monitoring platform or service supplied by a third party vendor.

8. The method of claim 1, wherein a customers' digital currency account is a digital currency wallet or account that is supplied by the vendor of the online software platform

9. The method of claim 1, wherein a customers' digital currency account is a digital currency wallet or account that is supplied by a third party vendor of digital currency accounts.

10. The method of claim 1, wherein a portion of the user selectable savings contribution can be optionally deposited into a non-digital currency account or investment vehicle; for example when a portion of the savings contribution is deposited into a traditional fiat currency savings account, share trading account, commodities investment account, personal investment account or a retirement account.

11. The method of claim 1, wherein all of the user selectable savings contribution can be optionally deposited into a non-digital currency account or investment vehicle; for example when all of the savings contribution is deposited into a traditional fiat currency savings account, share trading account, commodities investment account, personal investment account or a retirement account.
